(19) United States
(12) Patent Application Publication
(10) Pub. No.: US 2022/0071414 A1
(43) Pub. Date: Mar. 10, 2022

(54) FREESTANDING FLOOR DISPLAY OF CONSUMER PRODUCTS

(71) Applicant: Kimberly-Clark Worldwide, Inc., Neenah, WI (US)

(72) Inventors: Everest F. Doucette, III, New Milford, CT (US); Scott T. Hamylak, Brookfield, CT (US); Shailesh Patel, Marlboro, NY (US); Joseph E. Pierce, Appleton, WI (US); Nicholas D. Krueger, Greenville, WI (US); James T. Van Thiel, De Pere, WI (US); Katherine Naylor, Appleton, WI (US); Timothy J. Peters, Neenah, WI (US)

(21) Appl. No.: 17/465,359

(22) Filed: Sep. 2, 2021

Related U.S. Application Data
(60) Provisional application No. 63/074,760, filed on Sep. 4, 2020.

(51) Int. Cl. A47F 7/28; G09F 23/00; B65D 5/42; B65D 71/00; B65D 71/06

(52) U.S. Cl. CPC A47F 7/281; G09F 23/00; G09F 2023/0025; B65D 71/0088; B65D 71/06; B65D 5/425

(57) ABSTRACT

Disclosed are freestanding displays of packaged consumer products, particularly consumer paper products. The packaged consumer goods generally comprise one or more goods disposed in a carton, such as a folded paperboard box that is at least partially overwrapped with a film having a plurality of graphic elements disposed thereon. The graphic elements are preferably disposed on the film such that at least two panels of the resulting packages are visually similar, and two panels are visually distinct. The packages may be stacked in arrays to form a display having two more faces that are visually similar. The present freestanding display helps consumers recognize the packaged products from a distance even when displayed amongst other packaged goods in a crowded supermarket or club store.

### RELATED APPLICATIONS

The present application claims priority to U.S. Provisional Application No. 63/074,760, filed on Sep. 4, 2020, the contents of which are hereby incorporated by reference in a manner consistent with the present application.

### BACKGROUND

Freestanding floor displays are common in large stores, especially supermarkets and club stores, where many thousands of products are placed on the store floor for display and shopping. These displays often include packages of consumer goods stacked on a supporting medium, such as a pallet, rather than a permanent fixture, such as a store shelf. Such displays often serve a dual purpose of prominently displaying and promoting the packaged consumer goods. To be effective however, the packages must be easily recognizable, even when stacked with other packages, and when a portion of the packages have been shopped.

In certain instances, to increase visibility and improve the shopability of the packaged products, special advertising materials such as auxiliary banners may be added to the displays. These additional materials, however, add an extra expense and require additional maintenance by store personnel. The materials may also become ineffective or unsightly once a portion of the packages are removed from the display.

In other instances, to increase visibility and improve the shopability of the packaged products, the packages themselves may be specifically designed to be stacked together with other packages and displayed on a store floor. For example, the packages may have virtually identical graphics disposed on each package face so that they have a similar appearance when viewed from different perspectives. Further, the graphics may provide the display with an attractive uniform appearance, even when a portion of the packages have been removed. An additional benefit of such displays is that they may be loaded on the floor in multiple orientations, reducing the amount of care and attention required by store employees when placing the display on the store floor. While providing certain advantages however, such packaging limits the amount of information that can be communicated to the shopper as the package panels need to be virtually identical.

Accordingly, there remains a need for freestanding floor displays, particularly freestanding displays of packaged consumer goods, that both enhances the visibility and recognition of the goods and makes it easier for a shopper to select the correct product. There also remains a need for freestanding displays that are easy for retailers to maintain and organize.

### SUMMARY

It has now been found that the appearance and shopability of a freestanding display of packaged consumer goods may be improved by providing package graphics and a stacking configuration that produces a display having first and second end faces that are visually dissimilar and front and back faces that are visually similar. While the end faces are visually dissimilar, it is generally preferred that one of the end faces forms a billboard-like display. In this manner one of the end faces may be formed from the display faces of a plurality of bundled packages of consumer goods where the display face of each of the bundles are substantially identical. The present freestanding display helps consumers recognize the packaged products from a distance even when displayed amongst other packaged goods in crowded supermarkets, club stores, or the like.

In another embodiment the present invention provides a bundle of cartons comprising a plurality of individual cartons each having a carton length and a carton height where the carton length is greater than the carton height, the cartons stacked to form at least two rows and two columns of cartons, with the cartons of each row being longitudinally aligned with the cartons of an adjacent row and with the cartons of an adjacent column, the cartons overwrapped with a film to form a bundle having a bundle length and a bundle height where the bundle length is greater than the bundle height and the carton length and the bundle length are longitudinally aligned.

In still another embodiment the present invention provides a product display system for packages of consumer products having enhanced visibility and recognition. The product display system comprises a plurality of cartons of consumer goods stacked in rows and columns and overwrapped to form bundles that are further stacked into rows and columns for display. For example, the display may comprise a first stacked product array positioned adjacent to a second stacked product array wherein all of the packages in the first stacked array have a first package orientation and all of the packages in the second stacked array have a second package orientation where the first and second package orientations are substantially the same. Orienting the arrays in this manner produces a display having end faces formed by the same package panels, such as package back and front panels, while the front and back faces of the display may be formed entirely by package end panels.

In addition to orienting individual arrays of stacked packages such that the display end faces are formed by the same package panels, the appearance and shopability of the product display system may be further improved by selectively applying graphics to the various package panels. For example, the package may comprise a front panel, a back panel, and a pair of opposed end panels, wherein each of the panels have a plurality of graphic elements disposed thereon. The graphic elements may be disposed such that the front and back panels are visually distinct from one another and the end panels are visually similar.

By providing the packages with visually distinct front and back panels and visually similar first and second end panels, the amount of visual information that may be communicated to a consumer is increased compared to packages having visually similar graphics printed on each of the package panels. The amount of information communicated to a consumer is further enhanced by combining the foregoing packages into a display having display end faces formed by the same package panels and front and back faces formed entirely by package end panels. Thus, in another embodiment, the present invention provides a product display system for displaying a plurality of individual packages where the display front and back faces are visually dissimilar and the first and second end faces are visually similar.

In another embodiment the present invention provides a product display system for displaying a plurality of individual packages, also referred to as bundles, of consumer products having a top panel, a bottom panel, a front panel, two side panels, and a back panel, the display having a front face, a back face, and first and second end faces, the product display system comprising: a first array of individual packages stacked in a first column and a first row; a second array of individual packages stacked in a second column and a second row, each package within the first and second array oriented in the same direction such that the first end face is formed entirely by the individual package front panel. Further, because the first and second arrays are similarly oriented the front and back faces are formed from package side panels and preferably have a visually similar appearance.

In still another embodiment, the present invention provides a product display system for displaying a plurality of bundles of consumer products. The bundle of cartons comprising a plurality of individual cartons each having a carton length and a carton height where the carton length is greater than the carton height, the cartons stacked to form at least two rows and two columns of cartons, with the cartons of each row being longitudinally aligned with the cartons of an adjacent row and with the cartons of an adjacent column, the cartons overwrapped with a film to form a bundle having a bundle length and a bundle height where the bundle length is greater than the bundle height and the carton length and the bundle length are longitudinally aligned. Further, each bundle within the display comprises a front panel, a back panel, and first and second end panels, wherein each of the panels comprise a plurality of graphic elements disposed thereon and wherein the first and second end panels are visually similar to one another, and the front and back panels are visually distinct from one another. The display system is formed by a first array of bundles stacked in a first column and a first row, a second array of bundles stacked in a second column and a second row, each bundle within the first and second array oriented in the same direction such that the first end face is formed entirely by the bundle front panel. Additionally, the bundle graphics forming the first end face are visually similar to provide the display with a visually cohesive and attractive appearance.

In yet another embodiment the present invention provides a freestanding display comprising a plurality of packages comprising a plurality of individual cartons, wherein each carton has a length and a height where the carton length is greater than the carton height and wherein the plurality of cartons are stacked to form at least two rows and two columns of cartons, with the cartons of each row being longitudinally aligned with the cartons of an adjacent row and with the cartons of an adjacent column, and a film at least partially overwrapping the plurality of individual cartons to form a package having a package length and a package height where the package length is greater than package height, wherein the carton length and the package length are longitudinally aligned; a first array of packages stacked in a first column and a first row; and a second array of packages stacked in a second column and a second row; wherein each package within the first and second array are oriented in the same direction such that the package front panels form a display end face, and the package first end panels form a display front face.

### DESCRIPTION OF THE DRAWINGS

FIG. 1 is a perspective view of prior art bundle of cartons;

FIG. 2 is a perspective view of a bundle of cartons according to one embodiment of the present invention;

FIG. 3 is a perspective view of a bundle of cartons according to another embodiment of the present invention;

FIG. 4 is a plan view of a film overwrap comprising a plurality of graphics for overwrapping a plurality of cartons to form a bundle;

FIG. 5 is a perspective view of a display according to one embodiment of the present invention;

FIG. 6 is a perspective view of a display according to another embodiment of the present invention; and

FIG. 7 is a perspective view of a display according to still another embodiment of the present invention.

### DEFINITIONS

As used herein, the term “tissue product” refers to a wiping implement, particularly wiping implements designed for otorhinolaryngological discharges (facial tissue product) and/or multi-functional absorbent and cleaning uses (absorbent towel products, such as paper towel products and/or wipe products). The tissue products of the present invention may be in any suitable form, such as individual sheets, which may be connected or unconnected, arranged in a folded format an unfolded format.

As used herein, the term “carton” generally refers to an assembly capable of containing a consumer good and more particularly an assembly for retaining, storing, and displaying a plurality of consumer goods, such as tissue products. Cartons may be constructed from paper or plastic sheets, paperboard, or other foldable paper materials, such as cardboard or corrugated cardboard. Cartons may be cubic and have a length, which is the longest dimension, a width, and a height.

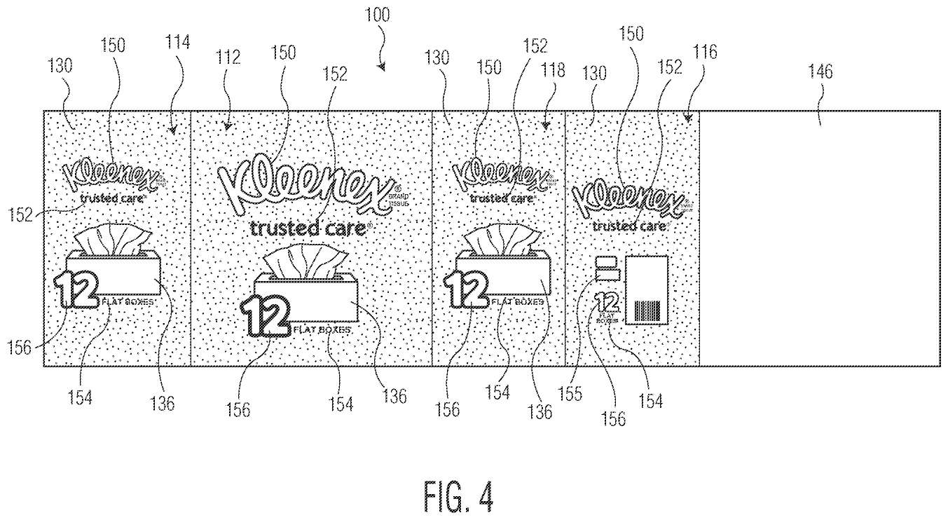

As used herein, the term “graphic element” means any design, pattern, indicia (including textual indicia and non-textual indicia), character representation, active pose, logo, or brand name. For example, with reference to FIG. 4, overwraps 100 useful in the present invention may include non-textual indicia such as a product representation's 136 graphic elements. The overwrap 100 may also include textual indicia such as a brand name 150 and a sub-brand 152. Textural indicia may also include a product descriptor 154, legal disclosure 155, an ingredient list, warnings, country of origin information, product quantity and size 156, all of which are graphic elements. A graphic element may be disposed on either cartons or film overwrap by any manner known in the art, such as printing, etching, laminating, gluing/adhesives, silk-screening, etc. In an embodiment herein, the graphic element is formed as part of the film overwrap that secures a plurality of cartons into bundle.

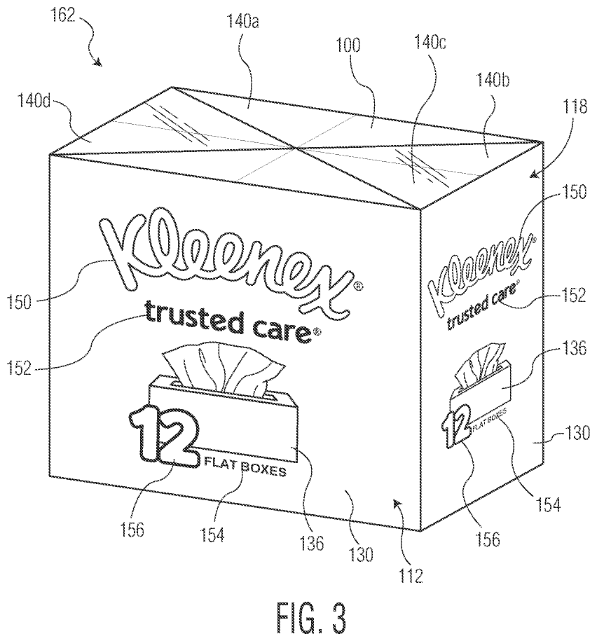

As used herein, the term “textual indicia” means text indicia, such as a word and/or phrase that communicates to a consumer a property about a product, such as a tissue product, it is associated with. In one example, such as that illustrated in FIG. 3, a plurality of cartons 140a-140d may be housed in a film overwrap 100 which includes textual indicia such as a brand name 150 and a sub-brand 152.

As used herein, “non-textual indicia” means non-text indicia that communicates to a consumer through a consumer's senses. In one example, non-textual indicia may communicate, even intuitively communicate, to a consumer through sight—a visual non-textual indicia. Nonlimiting examples of non-textual indicia include colors, patterns, textures such as emboss patterns and/or emboss pattern images or images of patterns, character representations, for example character representations exhibiting an active pose, and mixtures thereof. With reference to FIG. 3, one example of a non-textual indicia is a background pattern 130, also referred to herein simply as a background, that may have a color or a pattern that distinguishes the background pattern 130 from other graphic elements, such as a product representation 136.

As used herein, the term “visually distinct” when comparing the visual appearance of two panels of a carton to one another means that 50% or fewer of the graphical elements disposed on a first panel are disposed on a second panel in a substantially similar manner, such as in a similar shape, size, scale, and color. For example, with reference to FIG. 4, the back panel 116 is visually distinct from the front panel 112 because only four graphic elements—brand name 150, sub-brand 152, product descriptor 154 and quantity 156, of the ten graphic elements disposed on the back panel 116 are also disposed on the front panel 112 in a substantially similar manner.

As used herein, the term “visually similar” when comparing the visual appearance of two panels of a carton to one another means that more than 50% of the graphical elements disposed on a first panel are disposed on a second panel in a substantially similar manner, such as in a similar shape, size, scale, and color. For example, with reference to FIG. 4, the first end panel 114 is visually similar to the second end panel 118 because all of the graphic elements disposed on the first end panel 114, namely the background pattern 130, brand name 150, sub-brand 152, product representation 136, product descriptor 154 and product quantity 156 are disposed on the second end panel 118 in a substantially similar manner.

### DETAILED DESCRIPTION

The present invention provides freestanding displays of packaged consumer products, particularly consumer paper products, such as tissue products, and more particularly tissue products disposed in cartons, such as folded facial tissue. The packages generally comprise consumer products disposed within a carton. Cartons are well known in the art, particularly cartons for storing and dispensing folded sheets such as tissue sheets. For example, the invention may comprise cartons for dispensing tissue sheets having a top panel with a central opening, often having an elongated dimension, through which the tissues are dispensed. One common type of tissue carton is commonly referred to as a flat carton. In a flat carton the tissues are laid flat into the carton and are withdrawn from the top of the carton or through an opening in the top which partially extends downward into the front sidewall. The tissues within the carton may be interfolded for pop-up dispensing or merely laid on top of one another for reach-in dispensing. Various examples of flat tissue cartons are disclosed in U.S. Pat. Nos. 2,519,261, 3,239,097 and 3,369,699.

In a particularly preferred embodiment, the display of the present invention comprises a plurality of bundled tissue cartons adapted for storing and dispensing folded sheets of facial tissue. The tissue cartons 140 may be formed from paperboard and have folded end panels 141 and a surfboard covering the carton opening, as illustrated in FIG. 2. Tissue cartons useful in the present invention may have a cubic shape, particularly a rectangular shape, with a length (l), a width, and height (h) where the length (l) is generally the longest dimension.

Cartons are generally bundled together and secured for display according to the present invention. In one particularly preferred embodiment, a plurality of cartons, such as 8, 12, or 16 individual cartons, are bundled together and overwrapped with a wrapper, which may consist of a paper or film sheet material. Wrappers are well known in the art and may be a paper or a plastic film. Particularly preferred are thermoplastic films with the thermoplastic being either a monolayer or a laminate. While in certain embodiments, such as the embodiment illustrated in FIG. 2, the film overwrap 100 substantially encloses a plurality of cartons 140 to form a unitary package 162, also referred to herein as a bundle, the invention is not so limited. In other embodiments, the wrapper may be in the form of a band, or the like, so long as the plurality of cartons are secured in a stable manner and are joined to form a unitary package or bundle. Accordingly, in certain embodiments one or more sides of a bundle may remain entirely free of wrapper material or could be partially covered by the wrapper. Further, while in certain embodiments the wrapper may form the outer surface of the bundle, one skilled in the art will appreciate that the surfaces or faces of the carton may form a portion of the bundle outer surface.

With continued reference to FIG. 2, each of the cartons 140 are similarly shaped and sized. The cartons 140 are generally cubic with a length (l), a width, and a height (h). In the illustrated embodiment the carton length (l) is the longest dimension. The cartons 140 are arranged in carton columns 163a, 163b and carton rows 165a, 165b, 165c to form a bundle 162. In the illustrated embodiment, the twelve cartons 140 are stacked to form two columns 163a, 163b and three rows 165a-165c. Further, the cartons 140 are stacked such that each of the cartons 140 within a given row 165 is longitudinally aligned with the cartons 140 of an adjacent row 165 and with the cartons 140 of an adjacent column 163.

The cartons 140 are overwrapped with a film overwrap 100 to form a cubic bundle 162 having a bundle length (L), a bundle height (H), a bundle width (W). Generally, the bundle length (L) is greater than the bundle height (H) and the package length (L) is the longest longitudinal dimension of the bundle 162. Cartons 140 within the bundle 162 are arranged such that the carton length (l) and the bundle length (L) are longitudinally aligned with one another. In this manner, the present invention provides bundles 162 of cartons 140 where both the bundle 162 and the cartons 140 have a cubic shape and the cartons 140 are arranged such that for each carton 140, the carton longitudinal axis is parallel to the bundle longitudinal axis.

The bundle 162 generally comprises four panels (two of which are visible in FIG. 2)—a front panel 112, a first end panel 114, a back panel 116 and a second end panel 118. The unitary package 162 may be rotated about a vertical axis so that the various panels 112, 114, 116, 118 may be visible by a consumer. Thus, one of ordinary skill in the art will appreciate that when the bundle is assembled to contain a plurality of cartons the resulting bundle may be oriented in any number of different ways such that what is designated in illustrated embodiment, such as the embodiment of FIG. 2, as the back panel may be oriented to face a consumer viewing the package. As such, the designations, front, back and end, are merely used to describe the illustrated embodiment and are not meant to limit or otherwise restrict the scope of the invention.

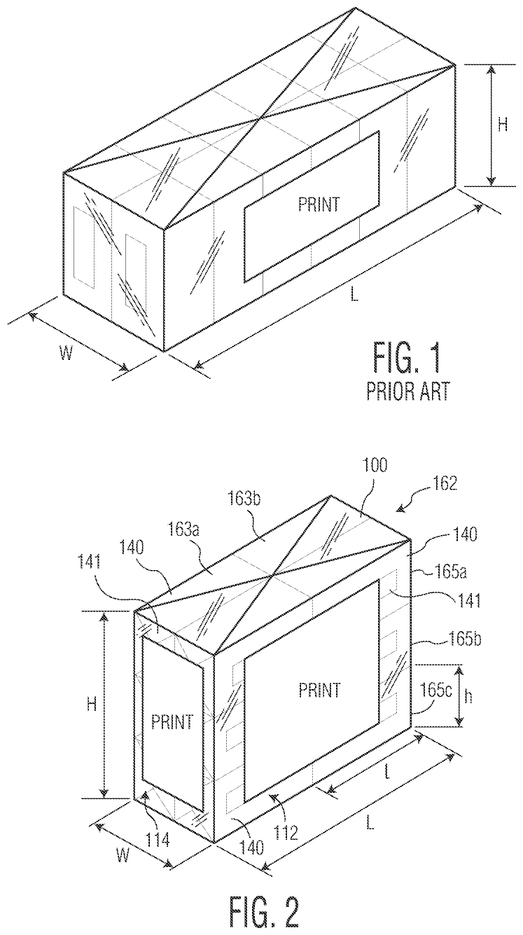

The bundle 162 illustrated in FIG. 2 comprises twelve individual cartons 140. Compared to prior art bundles comprising the same number of cartons, such as illustrated in FIG. 1, the bundles of the present invention generally have a height (H) greater than the bundle width (W). Further, the surface area of the front panel 112 is generally greater than surface area of the top panel 120, which is not the case for bundles of the prior art (illustrated in FIG. 1). Also, the percentage of the total bundle surface area made up by the front panel 112 is generally at least about 20%, more preferably at least about 22%, more preferably at least about 24% and still more preferably at least about 26%. In this manner, the bundles of the present invention have a significantly larger front panel on which to dispose graphic elements and to communicate more effectively with consumers.

To facilitate consumer communication, it is generally preferred that one or more of the bundle panels comprise a graphic element, which may be a design, pattern, indicia (including textual indicia and non-textual indicia), character representation, active pose, logo, or brand name. In certain embodiments graphic elements may be selected from the group consisting of a design, a pattern, a character representation, a pose, a product representation, a brand name, and a product descriptor. The number and types of graphic elements may vary amongst the panels, however, in a particularly preferred embodiment each panel comprises two or more graphic elements, more preferably three or more, still more preferably four or more, and even more preferably five or more, such as from about four to twelve graphic elements.

In certain preferred embodiments all of the bundles forming the display have graphic elements, such as textual indicia and non-textual indicia, thereupon which identifies the product, provides information to the consumer, and may also provide aesthetic benefits. The displays are particularly well suited for use in sales channels such as supermarkets and club stores where many thousands of products are provided in freestanding floor displays which include bundles stacked on a supporting medium, such as a pallet, rather than a permanent fixture such as a store shelf.

In certain preferred embodiments, such as the embodiment illustrated in FIG. 3, the bundle 162 may comprise non-textual indicia such as a product representation 136. The bundle 162 may also comprise textual indicia such as a brand name 150, a sub-brand 152, or other textual indicia, such as a product descriptor 154, which may describe one or more attributes of the packaged consumer goods.

The bundle front panel, back panel and end panels may all comprise a graphic element, however, certain portions of a given panel may not contain a graphic. For example, with reference now to FIG. 4, the back panel 116 may comprise an unprinted portion 146, which in certain preferred embodiments may be transparent. Providing a panel portion that is unprinted, or in certain preferred embodiments transparent, may provide the panel with a unique visual aesthetic and enable a consumer to view the packaged consumer product through the carton material.

Further, while all panels comprise a graphic element, it is generally preferred that at least two panels are visually distinct from one another. In a particularly preferred embodiment, the front and back panels are visually distinct from one another. For example, in certain embodiments, 10% or fewer of the front panel graphic elements may be substantially similar to graphic elements disposed on the back panel, such as 20% or fewer, such as 30% or fewer, such as 40% or fewer. In other embodiments the front panel may have four or fewer graphic elements that are disposed on the back panel in a substantially similar manner, such as three or fewer, such as two or fewer.

With continued reference to the overwrap 100 illustrated in FIG. 4, the front panel 112 and the back panel 116 are visually distinct from one another despite the front and back panels 112, 116 comprising certain elements, such as brand name 150 and sub-brand 152, that are similar. Despite these similarities the back panel 116 is visually distinct from the front panel 112 because only four of the ten back panel graphic elements, less than 50%, are also disposed on the front panel 112 in a similar manner.

While in certain embodiments the front and back panels are visually distinct from one another, the end panels may be visually similar to one another. By providing cartons having visually similar end panels, the cartons may be arranged in a freestanding display to provide display facings that are also visually similar, as will be discussed in more detail below. Accordingly, in certain preferred embodiments the end panels are visually similar to one another and have at least two, and more preferably at least three and still more preferably at least four substantially similar graphic elements. For example, with reference to the overwrap 100 illustrated in FIG. 4, the first end panel 114 has six graphic elements—a background pattern 130, a product representation 136, a brand name 150, a sub-brand name 152, product quantity 156, and a product descriptor 154—that are also disposed on the back panel 116 in a substantially similar manner.

By disposing substantially similar graphic elements on both end panels, the panels have a visually similar appearance. This is true even though the panels may include one or more graphic elements that differ. For example, the first end panel may include textual indicia such as an ingredient list, warnings, country of origin information, product quantity and size, and the like, that is not found on the second end panel. Although the graphic elements may differ between the end panels, in certain embodiments, it is preferred that more than 50% the graphical elements disposed on a first end panel are also disposed on the second end panel in a substantially similar manner, such as in a similar shape, size, scale and color.

Individual bundles may be stacked in arrays to form the display of the present invention. In certain embodiments the bundles may be stacked by hand and in other embodiments they may be stacked by a machine during the production process. Preferably the stacked product display comprises a plurality of cartons, such as a cardboard box, containing a consumer good, that have been stacked together and secured with a wrapper to form a bundle. The bundles are further stacked on a support structure, such as a pallet, in columns and rows to form a display. In certain instances, the bundles may be stacked to form the stacked product array and then overwrapped with a film to protect the display during transport.

Accordingly, in one embodiment the present invention provides a freestanding floor display of packaged consumer products, particularly consumer paper products, such as tissue products, and more particularly cartons containing facial tissue comprising a support medium, such as a pallet, and a plurality of substantially similar bundles of consumer products stacked thereon. In certain instances, it may be preferable to stack the packages such that none of the packages are overlapping one another and the packages are arranged in arrays of rows and columns. Further, the packages within a given stacked array may be oriented such that the display front and back facings are visually dissimilar such that the freestanding floor display may be placed on the store floor in several different orientations with similar visual affect.

In certain embodiments both the cartons forming the display and the resulting freestanding display have a cubic shape. The cartons are stacked in rows and columns on top of a support medium, such as a pallet, to form a display that may be placed on a store floor and displayed without any additional infrastructure. When displayed on a store floor the display may be freestanding and displayed on its own, or multiple displays may be stacked one on top of the other making more efficient use of floor space and increasing the visibility of the display from a distance.

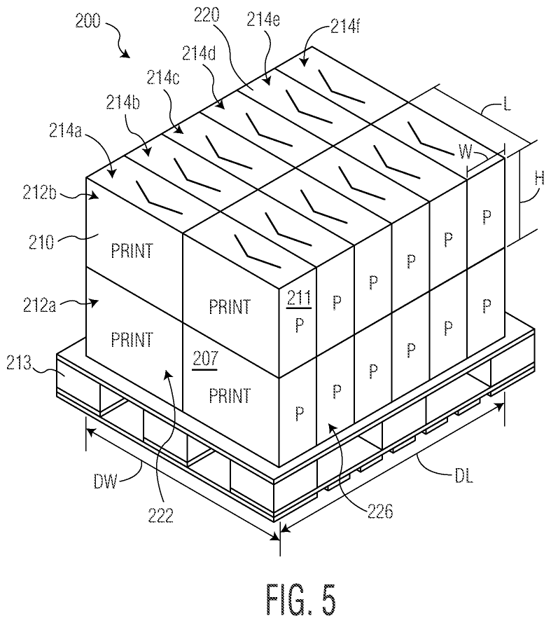

Turning now to FIG. 5, one embodiment of a free-standing display 200 is illustrated. The display 200 comprises a top 220, a bottom (not shown in FIG. 5), a first end face 222, a second end face (not shown in FIG. 5), a front face 226 and a back face (not shown in FIG. 5). The free-standing display 200 includes a plurality of bundles 210 stacked on a support medium 213, such as a pallet.

Each of bundles 210 have a bundle length (L) and a bundle width (W), opposed front and back panels (front panel 207 illustrated in FIG. 5), and opposed first and second end panels (first end panel 211 illustrated in FIG. 5). The bundles 210 are stacked in rows, such as first and second rows 212a, 212b, and columns, such as first through sixth columns 214a-214f. In the illustrated embodiment the first and second rows 212a, 212b each comprise twelve bundles 210, however, the invention is not so limited, and the rows may comprise four or more bundles 210. Similarly, while the illustrated embodiment comprises six columns the invention is not so limited and in alternate embodiments the display 200 may comprise two or more columns 214. In certain embodiments the display may contain from 2 to about 4 rows. In other embodiments the display may contain from 2 to 10 columns, such as from 2 to 8 columns, such as from about 2 to 6 columns.

With continued reference to FIG. 5, the display 200 has a display height, a display width (DW) and a display length (DL) that are generally defined by the rows 212 and columns 214 of stacked bundles 210 forming the display 200. In the illustrated non-liming embodiment, the display is two bundles 210 high, two bundles 210 wide and six bundles 210 long. These dimensions are merely illustrative and nonlimiting and the number of bundles forming a given dimension may vary depending on the dimension of individual bundles and the desired overall size of the display. Without intending to be limited by theory, it has been found that increasing both the height and width can significantly enhance visibility and recognition of individual packages in a display in a store-like environment, as compared to merely increasing height or width, alone.

In certain preferred embodiments each bundle is removably stacked within the display such that it can be repeatedly removed and replaced with the same bundle or another bundle. In other preferred embodiments, such as illustrated in FIG. 5, the bundles 210 are arranged such that bundles 210 within a given row 212a do not overlap those in an adjacent row 212b and those within a given column 214a do not overlap packages in an adjacent column 214b.

With continued reference to FIG. 5, in one embodiment, the bundles 210 are arranged within the display 200 such that their shortest dimension, generally the bundle width (W), forms the longest side of the display 200, the display length (DL), and the bundles' longest dimension, generally the bundle length (L), forms the shortest dimension, the display width (DW). When packages are oriented and stacked in the foregoing manner the resulting display front and back faces may be formed by the package end panels and the first and second end faces may be formed by the package back and front panels. For example, as illustrated in FIG. 5, the first end face 222 may be formed by the bundle front panels 207 and the front face 226 may be formed by bundle first end panels 211.

The bundles 210 may further be stacked and arranged such that all of the bundles 210 in a first row 212a and first column 214a are oriented in a first direction and all of the bundles 210 in a second, immediately adjacent, second row 212b and first column 214a are oriented in the same direction. When the bundles 210 are arranged in the foregoing manner, the first end face 222 comprises a first column 214a facing formed by bundle front panels 207. Thus, the display first end face 222 is formed entirely by bundle front panels 207 and the display front face 226 is formed entirely by package side panels 211.

In a particularly preferred embodiment, the display front face consists entirely of bundle first end panels which are visually similar to bundle second end panels, which form the entirety of the display back face. In this manner the display front and back faces are visually similar, and the display may be placed on a store floor with either the front facing, or the back facing oriented towards the shopper with similar visual effect. The ability of the display to be placed on the store floor in multiple orientations with the same visual effect simplifies placement of the display, saving store personnel time and effort, and presents a cohesive and consistent graphical display to the shopper.

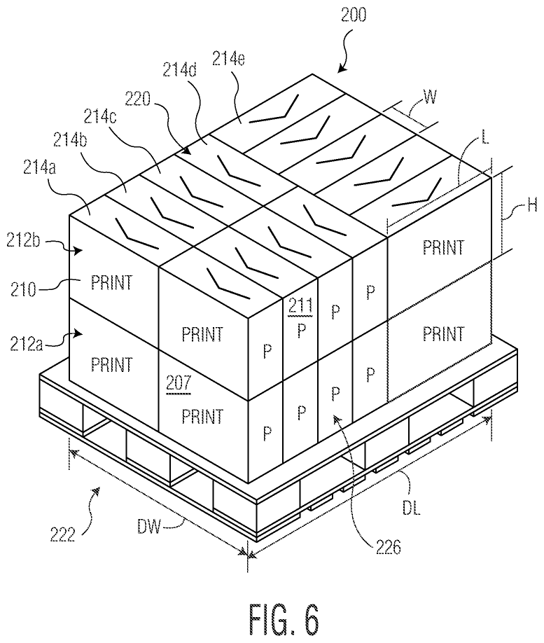

In other embodiments, such as that illustrated in FIG. 6, the display 200 may comprise bundles 210 stacked to form a first column 214a with the bundles 210 oriented such that the first display end 222 is formed by bundle front panels 207. The display 200 further comprises a column 214e of stacked bundles 210 oriented approximately 90° relative to the first column 214a. The foregoing orientation of first columns 214a-214d and last column 214e provide a first end face 222 and a second end face (not shown in FIG. 6) that are visually dissimilar and a front display face 226 and a back display face (not shown in FIG. 6) that are visually similar, albeit mirror images of one another. Further, the foregoing stacking configuration provides the display 200 with three faces (front 226 and first 222 and second (not shown) ends) formed at least partially from the bundle front panels 207, which generally have more surface area than other bundle panels and have a plurality of graphic elements disposed thereon to effectively communicate with consumers.

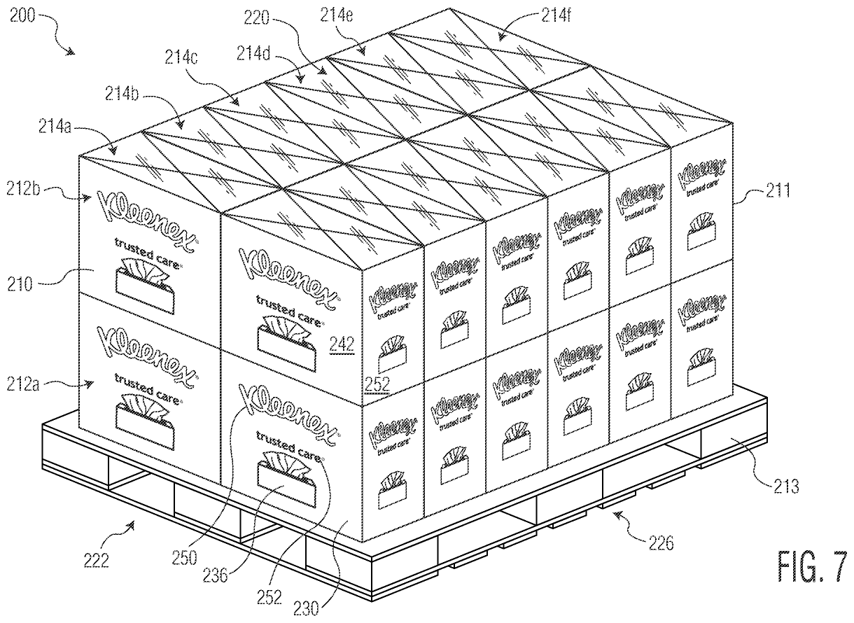

With reference now to FIG. 7, one particularly preferred display 200 is illustrated. Each of the bundles 210 comprise a plurality of graphic elements such as a background pattern 230, a product representation 236, a brand name 250, sub-brand 252, and textual indicia, such as a product descriptor. In certain embodiments all of the bundle panels include at least one graphic element, such as a background pattern 230 a product representation 236, a brand name 250, and a sub-brand 252 that are visually similar in terms of shape, size, scale, color, or pattern amongst the panels so as to draw consumers' attention to the display and provide for a visually aesthetic and cohesive display. In a particularly preferred embodiment, such as that illustrated in FIG. 7, the bundle front 226 and side panel 222 share a background pattern 230, a product representation 236, a brand name 250, and a sub-brand 252 and are visually similar so as to provide a visually aesthetic and cohesive display. Further, although not visible in FIG. 7, it may be desirable to arrange the bundles such that display front 226 and back (not shown in FIG. 7) faces are visually dissimilar and communicate with a consumer through different means.

What is claimed is:

1. A freestanding display having a front face, a back face, a first end face, and a second end face, the display comprising:
a plurality of individual packages of consumer products, each package having a back panel, a front panel, a first end panel and a second end panel and a plurality of graphic elements disposed on at least the front panel and the first end panel;
a first array of individual packages stacked in a first column and first and second rows, each package within the first array oriented in a first direction such that the package front panel forms a portion of the first end face of the display; and
a second array of individual packages stacked in a second column and first and second rows, each package within the second array oriented in the same direction as the packages in the first array such that the package front panels of the first and second arrays form a portion of the first end face of the display,
wherein the package front panels of the first and the second array are visually similar to one another.

2. The freestanding display of claim 1, wherein the display front face is formed entirely from package first end panels, the display back face is formed entirely from package second end panels and the package first and second end panels are visually similar to one another.

3. The freestanding display of claim 1, wherein all of the packages are oriented in the same direction.

4. The freestanding display of claim 1, wherein the packages are cubic, and the dimensions of each individual package are substantially similar.

5. The freestanding display of claim 1, wherein each individual carton is removably stacked.

6. The freestanding display of claim 1, wherein the individual packages are stacked on a supporting medium.

7. The freestanding display of claim 1, wherein each package panel comprises a plurality of graphic elements disposed thereon and wherein the first and second end panels are visually similar to one another and the front and back panels are visually dissimilar.

8. The freestanding display of claim 7, wherein the first and second end panels are visually dissimilar from the back panel.

9. The freestanding display of claim 1 wherein the graphic elements comprise at least one of textual indicia, non-textual indicia, and combinations thereof.

10. The freestanding display of claim 1 wherein the graphic elements comprise at least one non-textual indicia selected from the group comprising background pattern, background color, a product representation, a character, a character representation exhibiting an active pose, and combinations thereof.

11. The freestanding display of claim 1, wherein the packages comprise a plurality of individual cartons each having a carton length and a carton height where the carton length is greater than the carton height, the cartons stacked to form at least two rows and two columns of cartons, with the cartons of each row being longitudinally aligned with the cartons of an adjacent row and with the cartons of an adjacent column, the cartons overwrapped with a film to form a package having a package length and a package height where the package length is greater than package height and the carton length and the package length are longitudinally aligned.

12. A package of cartons comprising:
a. a plurality of individual cartons each having a carton length and a carton height where the carton length is greater than the carton height, the cartons stacked to form at least two rows and two columns of cartons, with the cartons of each row being longitudinally aligned with the cartons of an adjacent row and with the cartons of an adjacent column; and
b. a film at least partially overwrapping the plurality of individual cartons to form a package having a package length and a package height where the package length is greater than package height, wherein the carton length and the package length are longitudinally aligned.

13. The package of cartons of claim 12 wherein each of the plurality of cartons are cubic and have substantially similar dimensions.

14. The package of cartons of claim 12 wherein each package comprises a back panel, a front panel, a first end panel and a second end panel and a plurality of graphic elements disposed on at least the front panel and the first end panel.

15. The package of cartons of claim 14 wherein each package panel comprises a plurality of graphic elements disposed thereon and wherein the first and second end panels are visually similar to one another and the front and back panels are visually dissimilar.

16. The package of cartons of claim 15 wherein the first and second end panels are visually dissimilar from the back panel.

17. A freestanding display comprising a plurality of packages according to claim 12 stacked in a first array comprising a first column and first and second rows, each package within the first array oriented in a first direction such that the package front panel forms a portion of the first end face of the display; and a plurality of packages according to claim 12 stacked in a second array comprising a second column and first and second rows, each package within the second array oriented in the same direction as the package in the first array such that the package front panels of the first and second arrays form a portion of the first end face of the display, wherein the package front panels of the first and the second array are visually similar to one another.

18. The freestanding display of claim 17 wherein the display front face is formed entirely from package first end panels, the display back face is formed entirely from package second end panels and the package first and second end panels are visually similar to one another.

19. The freestanding display of claim 17 wherein all of the packages are oriented in the same direction.
